(19) United States
(12) Patent Application Publication
(10) Pub. No.: US 2021/0065309 A1
(43) Pub. Date: Mar. 4, 2021

(54) Accounting Management Apparatus, Method and System

(71) Applicant: Hitachi, Ltd., Tokyo (JP)

(72) Inventors: Sanae NAKAO, Tokyo (JP); Masayuki OYAMATSU, Tokyo (JP); Hirofumi NAGANO, Tokyo (JP); Shohei YAMAGATA, Tokyo (JP); Tatsuro TSUBONE, Tokyo (JP); Susumu KOBAYASHI, Tokyo (JP); Yu OSHIMOURA, Tokyo (JP)

(21) Appl. No.: 16/817,116

(22) Filed: Mar. 12, 2020

(30) Foreign Application Priority Data
Aug. 26, 2019 (JP) 2019-153461

(51) Int. Cl. G06Q 40/00; G06Q 10/06; H04L 9/06

(52) U.S. Cl. CPC G06Q 40/12; G06Q 10/06313; H04L 2209/56; H04L 9/0643; H04L 2209/38; G06Q 10/06315

(57) ABSTRACT

An accounting management apparatus configured to manage accounting of a first organization belonging to a set of organizations forming a group, the accounting management apparatus being accessible to accounting information including information about a project of the first organization and settlement information about the project, and the processor being configured to execute: an acquisition process of acquiring first settlement information about the project and second settlement information from the accounting information, the second settlement information being about a part of operation of the project by a second organization belonging to the group and having performed part of the operation; a compilation process of compiling the first settlement information and the second settlement information acquired by the acquisition process; and an output process of outputting a result of the compilation by the compilation process.

### CLAIM OF PRIORITY

The present application claims priority from Japanese patent application JP 2019-153461 filed on Aug. 26, 2019, the content of which is hereby incorporated by reference into this application.

### BACKGROUND

The present invention relates to an accounting management apparatus, an accounting management method, and an accounting management system.

To make a managerial decision promptly, there has been a need for all group companies to grasp an earnings structure not only on a period basis such as a one-year basis or a quarterly-period basis, but also on a project basis, without much expense in time and effort. Japanese Patent Application Publication No. 2009-205297 discloses a budget management technique on a project basis.

Japanese Patent Application Publication No. 2009-205297 discloses a development budget management apparatus including: a means of inputting project information including information about a development period, information about development cost, and information about a product group estimated in a project planning stage and storing the input project information as development plan information; a means of searching for development results information on the basis of the information about the product group and presenting a standard event schedule and an accrued budget item; and a means of storing the presented event schedule and accrued budget item into the development plan information after the presented event schedule and accrued budget item are confirmed or revised by a user. The accrued budget item and a budget accrual time are mapped to a development schedule to perform budget management conforming to a life cycle from a planning stage of product development to the completion of the development.

However, Japanese Patent Application Publication No. 2009-205297 is based on the assumption that budget management is to be performed within the same company. Hence, if operations are subcontracted to a different company, earnings within the cost of the operations subcontract cannot be grasped. If an organization responsible for general control over all group companies is to collect earnings information manually from each group company in order to grasp the earnings of all the group companies, problems arise in terms of taking more time and effort with the increase in group scale and there is a high likelihood of errors occurring.

### SUMMARY

The present invention is intended to permit an earnings structure on a project basis across group companies or consolidated companies to be grasped efficiently.

An aspect of the invention disclosed in this application is an accounting management apparatus configured to manage accounting of a first organization belonging to a set of organizations forming a group, comprising: a processor configured to execute a program; and a storage device configured to store the program, the accounting management apparatus being accessible to accounting information including information about a project of the first organization and settlement information about the project, and the processor being configured to execute: an acquisition process of acquiring first settlement information about the project and second settlement information from the accounting information, the second settlement information being about a part of operation of the project by a second organization belonging to the group and having performed part of the operation; a compilation process of compiling the first settlement information and the second settlement information acquired by the acquisition process; and an output process of outputting a result of the compilation by the compilation process.

A representative embodiment of the present invention permits the configuration of settlement information on a project basis across group companies or consolidated companies to be grasped efficiently. The details of one or more implementations of the subject matter described in the specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an explanatory view showing exemplary accounting management on a project basis performed in a group company.

FIG. 2 is an explanatory view showing an exemplary system configuration of an accounting management system.

FIG. 3 is a block diagram illustrating a hardware configuration example of the computers.

FIG. 4 is a block diagram showing an exemplary functional configuration of the accounting management apparatus.

FIGS. 5A and 5B are explanatory views showing exemplary transaction data registered with the distributed ledger.

FIG. 6 is an explanatory view showing exemplary channel settings.

FIG. 7 is an explanatory view showing an example of the channel setting information.

FIG. 8 is an exemplary view showing an example of the organization information.

FIG. 9 is an explanatory view showing an example of the personnel information.

FIG. 10 is an explanatory view showing an exemplary project registration screen.

FIG. 11 is an explanatory view showing an exemplary transaction screen.

FIG. 12 is an explanatory view showing an exemplary project coin issuance/cashing application screen.

FIG. 13 is an explanatory view showing an exemplary settlement screen.

FIG. 14 is an explanatory view showing an example of a first aggregate screen.

FIG. 15 is an explanatory view showing an example of a second aggregate screen.

FIG. 16 is a flowchart showing an exemplary procedure of a project coin issuance process performed by the currency issuance apparatus.

FIG. 17 is a flowchart showing an exemplary procedure of a settlement process performed by the settlement unit of the accounting management apparatus.

FIG. 18 is a flowchart showing an exemplary procedure of an earnings compilation process of an entire group performed by the accounting management apparatus of a group umbrella organization.

### DETAILED DESCRIPTION OF THE EMBODIMENT

### <Exemplary Accounting Management>

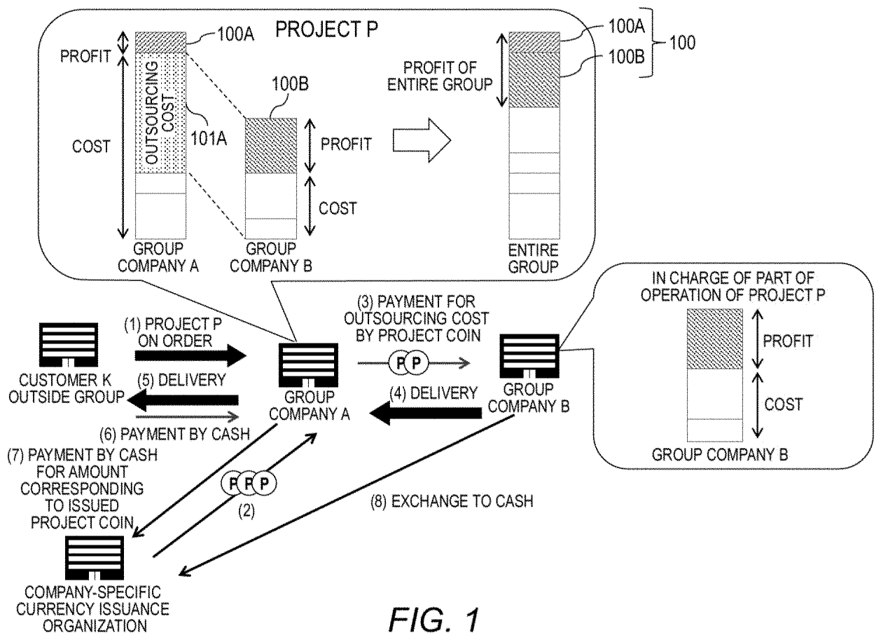

FIG. 1 is an explanatory view showing exemplary accounting management on a project basis performed in a group company. A project is an operation for attaining a purpose. While a group company is illustrated as an example in FIG. 1, accounting management may be performed in the same way in a consolidated company. A project-specific digital currency exchangeable to cash (hereinafter called a project coin) is used in this exemplary accounting management. As the project coin, a colored coin, which is a kind of virtual currency (also called a cryptocurrency or crypto-asset) is usable, for example. Virtual currencies or means other than colored coins are usable, as long as such currencies or means are exchangeable to cash. The exemplary accounting management will be described below in chronological order from (1) to (8).

(1) A customer K outside a group places an order for a project P to a group company A. The group company A is a group umbrella organization (a parent company) responsible for general control over the group. In this embodiment, the group company A gains a profit 100A for receipt of the order for the project P. Cost of the project P includes outsourcing cost 101A to be paid to a group company B.

(2) The group company A has a company-specific currency issuance organization issue a project coin based on an amount of the order for the project P, etc. The project coin includes a project coin only available for a settlement relating to the project P, and a project coin generally available for a purpose other than the project P. The project coin issued in (2) is the former project coin. If a part of the former project coin is left unused at the time of the end of the project P, this then becomes available as the latter project coin.

(3) The group company A determines the group company B to be a destination of outsourcing for the project P, and pays outsourcing costs by the project coin to the group company B. In this embodiment, the group company B is a subsidiary company of the group company A. The group company B gains a profit 100B for the placement of the order from the group company A.

(4) After receiving payment for the outsourcing cost, the group company B delivers the requested product to the group company A.

(5) The group company A delivers the product from the group company B to the customer K outside the group.

(6) The customer K outside the group makes a payment in cash to the group company A.

(7) The group company A pays cash for an amount corresponding to the project coin issued in (2) to the company-specific currency issuance organization.

(8) The group company B has the company-specific currency issuance organization exchange the project coin paid from the group company A to cash.

As a result of the foregoing processes (1) to (8), the group company A, which is the group umbrella organization, becomes capable of grasping the profit 100A of the group company A and a profit 100 of the entire group. The group company B becomes capable of grasping the profit 100B.

As described above, the group company A, which is the group umbrella organization, can grasp an earnings structure on a project basis across the group companies without disclosing the profit 100A to the group company B. Further, the earnings structure on a project basis across the group companies can be grasped in a shorter time, so as to permit the making of a managerial decision promptly without losing timing. Wrongdoing (falsification) in accounting or in making a transaction can be prevented.

A project to be handled can be decided after consideration of profitability for the entire group. For example, the kind of project which will produce a high profit can be anticipated on the basis of past records. Moreover, the kind of project which will produce a high profit for the entire group, even while not producing a high profit for a single organization, can be determined to be employable.

### <Accounting Management System>

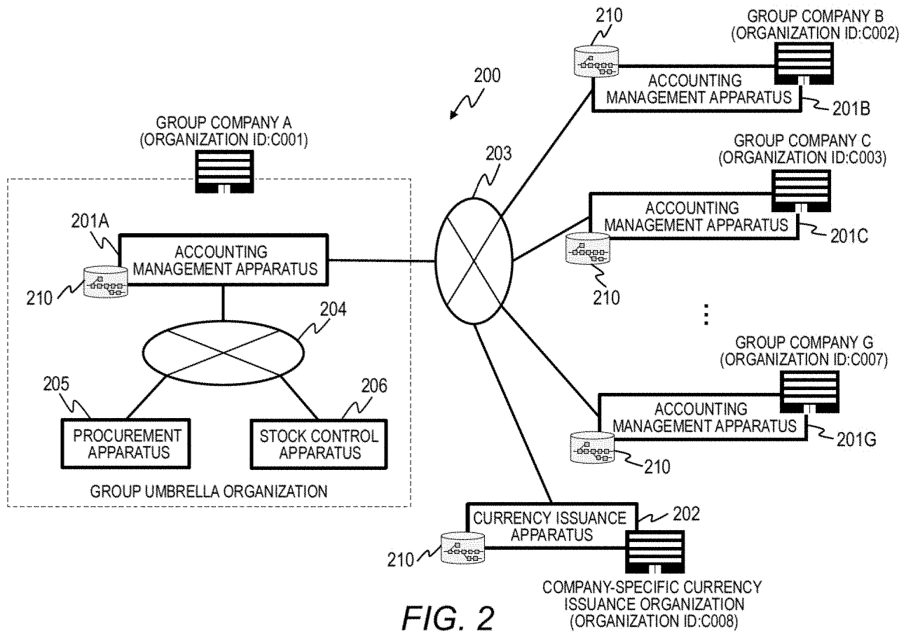

FIG. 2 is an explanatory view showing an exemplary system configuration of an accounting management system. An accounting management system 200 includes a plurality of (for example, seven in FIG. 2) accounting management apparatuses 201A to 201G, and a currency issuance apparatus 202. If the accounting management apparatuses 201A to 201G are not to be distinguished from each other, these apparatuses will be called an accounting management apparatus 201X. The accounting management apparatuses 201A to 201G and the currency issuance apparatus 202 are connected communicably to each other through a peer-to-peer first network 203. The first network 203 is a local area network (LAN), a wide area network (WAN), or the Internet, for example, and may either be a wired or wireless network. The accounting management apparatuses 201A to 201G and the currency issuance apparatus 202 have a common distributed ledger 210X.

The accounting management apparatus 201X is a computer for management of a budget for each project, transaction data 500, and settlement information. The accounting management apparatus 201X illustrated in FIG. 2 is a computer used by a group company X. In this example, among group companies A to G, the group company A functions as a group umbrella organization. While the configuration of FIG. 2 is such that each of the group companies A to G owns one of the accounting management apparatuses 201A to 201G, the configuration may also be such that the accounting management apparatus 201X is owned by each organization in a company. The accounting management apparatus 201X is realized using a computer installed in a system center or a data center, for example. The accounting management apparatus 201X may be realized virtually as a cloud server.

The currency issuance apparatus 202 is a computer used by a company-specific currency issuance organization. The currency issuance apparatus 202 issues a specific project coin for a project for which issuance of a project coin has been applied. Further, the currency issuance apparatus 202 accepts an application for an exchange of a project coin to cash and determines whether the cashing is permissible. If the cashing is permissible, the currency issuance apparatus 202 exchanges the project coin to cash.

The accounting management apparatus 201A is connected communicably to a procurement apparatus 205 and a stock control apparatus 206 through a second network 204. The second network 204 is a local area network (LAN), a wide area network (WAN), or the Internet, for example, and may either be a wired or wireless network.

The procurement apparatus 205 is a computer to manage and assist in operation of purchasing or procuring of parts, etc. if there arises a need for such transactions between companies and between departments in a company. The stock control apparatus 206 is a computer for control of a stock situation of products or parts. The stock control apparatus 206 allocates stock and updates stock information if there arises a need for such allocations and updates during transactions between companies and between departments in a company. In a case of a company which provides only services not involving stock, the stock control apparatus 206 may be omitted from the configuration of this system. While the procurement apparatus 205 and the stock control apparatus 206 shown in FIG. 2 are managed by the group company A, the other group companies B to G may also have the same apparatuses.

### <Hardware Configuration Example of the Computers>

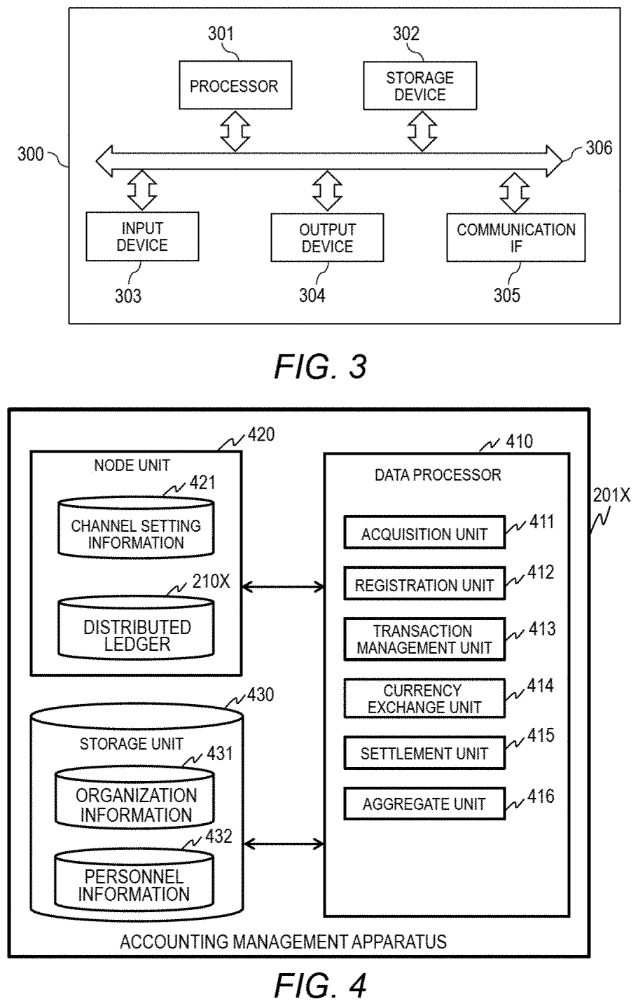

FIG. 3 is a block diagram illustrating a hardware configuration example of the computers. Each computer includes a processor 301, a storage device 302, an input device 303, an output device 304, and a communication interface (communication IF) 305. The processor 301, the storage device 302, the input device 303, the output device 304, and the communication IF 305 are connected to one another by a bus 306. The processor 301 controls the computer. The processor 301 executes various programs. The storage device 302 serves as a work area of the processor 301. The storage device 302 is a non-transitory or temporary recording medium which stores the various programs and data. The storage device 302 can be, for example, a read-only memory (ROM), a random access memory (RAM), a hard disk drive (HDD), or a flash memory. The input device 303 inputs data. The input device 303 can be, for example, a keyboard, a mouse, a touch panel, a ten-key pad, or a scanner. The output device 304 outputs data. The output device 304 can be, for example, a display, a printer or a speaker. The communication IF 305 couples to a network to transmit and receive data.

### <Exemplary Functional Configuration of Accounting Management Apparatus 201X>

FIG. 4 is a block diagram showing an exemplary functional configuration of the accounting management apparatus 201X. The accounting management apparatus 201X includes a data processor 410, a node unit 420, and a storage unit 430. The data processor 410 includes an acquisition unit 411, a registration unit 412, a transaction management unit 413, a currency exchange unit 414, a settlement unit 415, and an aggregate unit 416.

Specifically, the data processor 410 is realized by causing the processor 301 to execute a program stored in the storage device 302, for example. Specifically, the node unit 420 and the storage unit 430 are realized by the storage device 320, for example. Realizing the data processor 410, the node unit 420, and the storage unit 430 using a smart contract is expected to achieve the effect of shortening a processing period or preventing wrongdoing.

The node unit 420 includes channel setting information 421 and the distributed ledger 210X. The channel setting information 421 is information containing the set information of one or more channels defining an accounting management apparatus of a different organization to become a partner in the communication of information. Namely, the channel setting information 421 is a table defining which accounting management apparatus 201X of which organization participates in which channel. Two or more accounting management apparatuses 201X participating in the same channel transmit and receive transaction data to and from each other.

The distributed ledger 210X contains accounting information as transaction data shared through the first network 203 as transaction data. The accounting information is information containing incoming and outgoing flows of money (including virtual currencies) and products. The distributed ledger 210X is configured using a block chain, for example. If transaction data is written into the distributed ledger 210X of a certain accounting management apparatus 201X, this accounting management apparatus 201X refers to the channel setting information 421, and transmits the written transaction data through the first network 203 only to an accounting management apparatus 201Y participating in a channel designated in the transaction data. The accounting management apparatus 201Y receives the transaction data from the accounting management apparatus 201X, and writes the received transaction data into a distributed ledger 210Y. The transaction data includes project information, transaction information, and settlement information. The project information, the transaction information, and the settlement information are included in the accounting information.

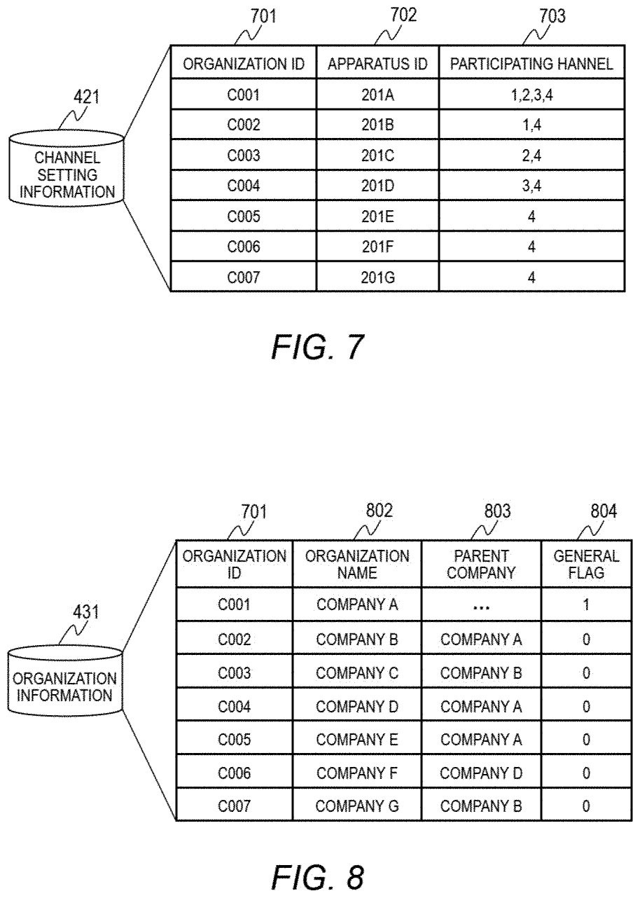

The storage unit 430 stores organization information 431 and personnel information 432. The storage unit 430 manages the organization information 431 and the personnel information 432 as a table in a database in a text file or a relational database management system (RDBMS), for example. The organization information 431 and the personnel information 432 may be configured to be stored entirely or partially in a different server through the first network 203. The organization information 431 and the personnel information 432 will be described in detail later by referring to FIGS. 7 to 9.

The acquisition unit 411 accepts the input of various types of information from an input device belonging to the accounting management apparatus 201X or from an external device connected through the first network 203. As an example, the acquisition unit 411 accepts the input of information such as contract details, a budget, or execution instructions for processing of a project which is a target of an accounting management process from the input device 303 or the external device. Further, the acquisition unit 411 acquires information from the distributed ledger 210X that has been designated by the input device 303 or the external device. Moreover, the acquisition unit 411 transfers the acquired information to corresponding predetermined functional units (registration unit 412, transaction management unit 413, currency exchange unit 414, settlement unit 415, and aggregate unit 416).

The registration unit 412 performs a process of registering a project started in response to an order received from a customer or activities within a company. The registration unit 412 registers information about the project such as contract details, a budget, etc. as project information with the distributed ledger 210X. If a budget is not determined at the time of registration of the project, the budget may be registered after being determined. When the registration unit 412 registers accounting information with the distributed ledger 210X, the registration unit 412 sets access rights to this accounting information. The access rights can be controlled by making the node unit 420 of each accounting management apparatus 201X refer to the channel setting information 421 for managing a channel in a block chain to which this accounting management apparatus 201X belongs. The access rights are controlled using a channel in the example described in this embodiment. However, as long as the access rights can be controlled using a comparable mechanism, a channel is not always required to be used for control.

The transaction management unit 413 manages information about transactions such as the giving and receipt of orders between companies and between departments in a company, and registers the managed information with the distributed ledger 210X. The transaction data 500 registered with the distributed ledger 210X is shared between the distributed ledgers 210X of the accounting management apparatuses 201 of all companies and organizations connected through the first network 203 according to a set of access rights to a corresponding project registered by the registration unit 412.

The information managed by the transaction management unit 413 includes information necessary for operations such as purchasing or procuring parts, etc. Such information is input through the second network 204 to the procurement apparatus 205 and then the procurement operations are performed using a widely-known general method. The information managed by the transaction management unit 413 includes information necessary for stock allocation, for example. Such information is input through the second network 204 to the stock control apparatus 206 and then stock allocation is executed.

The currency exchange unit 414 accepts an application for the issuance of a project coin, and registers the contents of the application with the distributed ledger 210X. In response to the project coin issuance application registered with the distributed ledger 210X, if the content of the application is permissible, the currency issuance apparatus 202 issues the project coin and registers information about the issuance with the distributed ledger 210X. For example, if the project coin was issued in the past and a total amount including an application amount exceeds a budget, the currency issuance apparatus 202 may determine that the issuance of the project coin is impermissible.

The currency exchange unit 414 accepts an application for exchange of a project coin to cash, and registers the contents of the application with the distributed ledger 210X. In response to the project coin cashing application registered with the distributed ledger 210X, if the cashing is permissible, the currency issuance apparatus 202 registers information indicating the same with the distributed ledger 210X. If a corresponding project has been finished or cash is needed for payment to the outside, for example, the currency issuance apparatus 202 determines that the cashing is permissible.

The currency exchange unit 414 accepts a request for the checking of a project issuance status, calculates an issuance upper limit amount and a total issued amount of this project coin on the basis of transaction data registered with the distributed ledger 210X, and outputs the calculated amounts to the output device 304. As an example, a budget amount registered as project information is set as the issuance upper limit amount of this project coin.

The settlement unit 415 makes a settlement by a project coin relating to a project in a company to which the project coin is available to be used, and registers information about the settlement with the distributed ledger 210X. The settlement information registered with the distributed ledger 210X is shared between the distributed ledgers 210X of the accounting management apparatuses 201 in corresponding companies and organizations connected through the first network 203 according to a right of access to this project registered by the registration unit 412.

The settlement unit 415 makes a settlement by cash relating to a transaction with a company other than a company to which a project coin is available to be used, and registers information about the settlement with the distributed ledger 210X. The settlement by cash may be made using a widely-known conventional method such as a settlement through a financial institution, and so will not be described in detail in this embodiment. While a settlement using a project coin or cash is described as an example in this embodiment, a widely-known general settlement method such as a credit card settlement may be set as an available method, for example.

The aggregate unit 416 compiles the information registered with the distributed ledger 210X from a variety of viewpoints, and outputs a result. For example, the aggregate unit 416 can collect information about a plurality of projects in the same organization, and make a comparison in terms of a difference or profit between a budget and a result. Further, the aggregate unit 416 can collect information about an arbitrary project across group companies, and output a profit from this project for the entire group.

<Exemplary Transaction Data Registered with Distributed Ledger 210X>

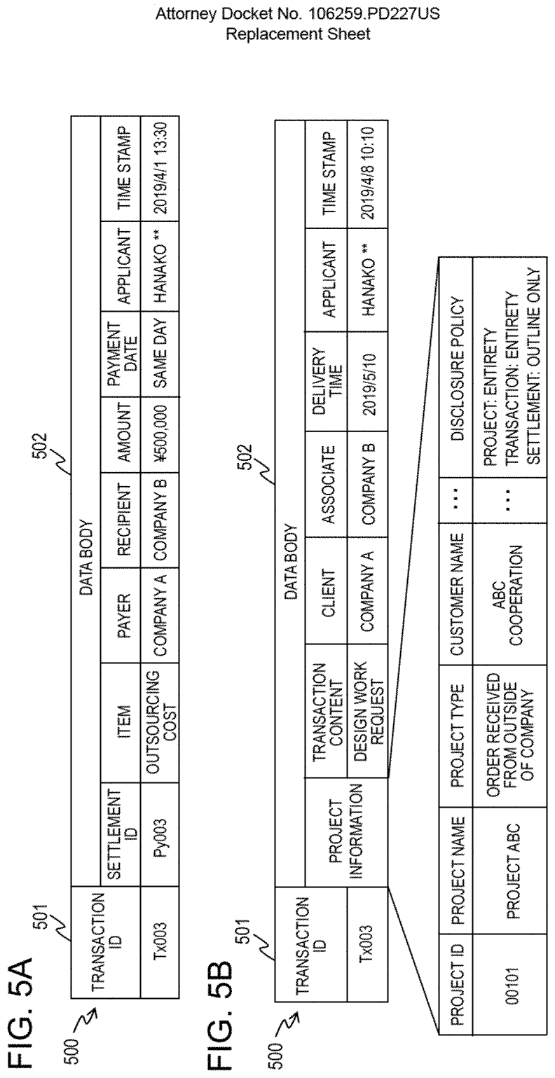

FIGS. 5A and 5B are explanatory views showing exemplary transaction data registered with the distributed ledger 210X. FIG. 5A shows an exemplary data structure of the transaction data 500 about settlement information. FIG. 5B shows an exemplary data structure of the transaction data 500 about transaction information.

The transaction data 500 includes a Transaction ID 501 and a Data body 502. In the case of FIG. 5A, the Data body 502 includes a Settlement ID, an Expense item, a Payer, a Recipient, an Amount, a Payment date, an Applicant, and a Time stamp. In the case of FIG. 5B, the Data body 502 includes Project information, Transaction content, a Client, an Associate, a Delivery time, an Applicant, and a Time stamp. The Project information includes a Project ID, a Project name, a Project type, a Customer name, and a Disclosure policy. While not shown, the Data body 502 includes a public key or an electronic signature of an applicant, and a public key to a destination of transmission (recipient or associate) of the transaction data 500. The transaction data 500 is stored in each block of a block chain constructed in the distributed ledger 210X.

### <Exemplary Channel Settings>

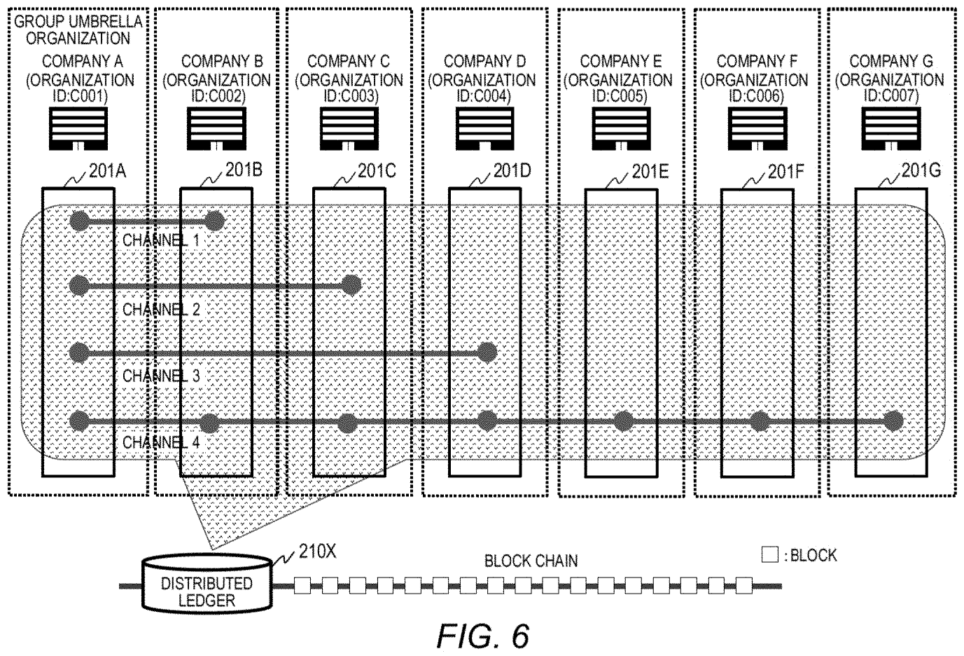

FIG. 6 is an explanatory view showing exemplary channel settings. The transaction data 500 is registered with the distributed ledger 210X of the accounting management apparatus 201X, which is a transmission destination. Further, the transaction data 500 is transmitted only to the accounting management apparatus 201Y of a company Y participating in a channel designated by the accounting management apparatus 201X, and registered with the distributed ledger 210Y of the accounting management apparatus 201Y.

A channel 1 is a channel in which the company A and the company B participate. Thus, transaction data pieces 500 from the accounting management apparatuses 201A and 201B are registered only with a distributed ledger 210A and a distributed ledger 210B of the accounting management apparatuses 201A and 201B. In this way, these transaction data pieces 500 are shared between the company A and the company B.

It is assumed, for example, that the accounting management apparatus 201A designates the channel 1 and generates the transaction data 500 about the Settlement information shown in FIG. 5A. The accounting management apparatus 201A registers the generated transaction data 500 with the distributed ledger 210A and transmits the generated transaction data 500 to the accounting management apparatus 201B of the company B participating in the channel 1. The accounting management apparatus 201B registers the received transaction data 500 with the distributed ledger 210B. In this case, as the accounting management apparatuses 201C to 201G do not participate in the channel 1, the accounting management apparatus 201A does not transmit the generated transaction data 500 to the accounting management apparatuses 201C to 201G. This prohibits the accounting management apparatuses 201C to 201G from registering the generated transaction data 500 with their distributed ledgers 210C to 210G.

It is also assumed that the accounting management apparatus 201B designates the channel 1 and generates the transaction data 500 about the settlement information shown in FIG. 5A. The accounting management apparatus 201B registers the generated transaction data 500 with the distributed ledger 210B and transmits the generated transaction data 500 to the accounting management apparatus 201A of the company A participating in the channel 1. The accounting management apparatus 201A registers the received transaction data 500 with the distributed ledger 210A. In this case, as the accounting management apparatuses 201C to 201G do not participate in the channel 1, the accounting management apparatus 201B does not transmit the generated transaction data 500 to the accounting management apparatuses 201C to 201G. This prohibits the accounting management apparatuses 201C to 201G from registering the generated transaction data 500 with their distributed ledgers 210C to 210G.

A channel 2 is a channel in which the company A and the company C participate. Thus, transaction data pieces 500 from the accounting management apparatuses 201A and 201C are registered only with the distributed ledgers 210A and 210C of the accounting management apparatuses 201A and 201C. In this way, these transaction data pieces 500 are shared between the company A and the company C.

A channel 3 is a channel in which the company A and the company D participate. Thus, transaction data pieces 500 from the accounting management apparatuses 201A and 201D are registered only with the distributed ledgers 210A and 210D of the accounting management apparatuses 201A and 201D. In this way, these transaction data pieces 500 are shared between the company A and the company D.

Likewise, a channel 4 is a channel in which the companies A to G participate. Thus, transaction data pieces 500 from the accounting management apparatuses 201A to 201G are registered with the distributed ledgers 210A to 210G of the accounting management apparatuses 201A and 201G. In this way, these transaction data pieces 500 are shared among the companies A to G.

It is assumed, for example, that the accounting management apparatus 201A designates the channel 4 and generates the transaction data 500 about the transaction information shown in FIG. 5B. The accounting management apparatus 201A registers the generated transaction data 500 with the distributed ledger 210A, and transmits the generated transaction data 500 to the accounting management apparatuses 201B to 201G of the companies B to G participating in the channel 4. The accounting management apparatuses 201B to 201G register the received transaction data 500 with the distributed ledgers 210B to 210G.

It is also assumed that the accounting management apparatus 201B designates the channel 4 and generates the transaction data 500 about the transaction information shown in FIG. 5B. The accounting management apparatus 201B registers the generated transaction data 500 with the distributed ledger 210B, and transmits the generated transaction data 500 to the accounting management apparatuses 201A and 201C to 201G of the companies A and C to G participating in the channel 4. The accounting management apparatuses 201A and 201C to 201G register the received transaction data 500 with the distributed ledgers 210A and 210C to 210G. This also applies to the accounting management apparatuses 201C to 201G.

As described above, unlike conventional access rights management using a database, in each accounting management apparatus 201X, the transaction data 500 not to be shared is absent in the distributed ledger 210X of this accounting management apparatus 201X. This makes it possible to control access to the transaction data 500 more firmly to prevent wrongdoing or leakage of information.

### <Content of Storage in Storage Unit>

FIG. 7 is an explanatory view showing an example of the channel setting information 421. The channel setting information 421 includes an Organization ID 701, an Apparatus ID 702, and a Participating channel 704. As shown in FIG. 2, Organization ID 701 is identification information for identifying an organization X uniquely. Apparatus ID 702 is identification information for identifying the accounting management apparatus 201X uniquely. Participating channel 704 is a channel in which the accounting management apparatus 201X of the organization X identified by Organization ID 701 and Apparatus ID 702 participates. The accounting management apparatus 201X transmits the transaction data 500 to the different accounting management apparatus 201Y in the same Participating channel 704. If the accounting management apparatus 201X receives the transaction data 500 from the different accounting management apparatus 201Y in the same Participating channel 704, the accounting management apparatus 201X writes the received transaction data 500 into the distributed ledger 210X.

FIG. 8 is an exemplary view showing an example of the organization information 431. The organization information 431 includes managed information about a group company. The organization information 431 includes an Organization ID 701, an Organization name 802, a Parent company 803, and a General flag 804. The Organization name 802 is the name of an organization identified by the Organization ID 701. The Parent company 803 is a company having a stake of 50% or more in an organization and having an actual control over this organization. If an organization in each record is a subsidiary company of any organization, the Organization name 802 of the Parent company 803 is set in the Parent company 803 of the subsidiary company. This makes it possible to efficiently set sharing between organizations in a parent-subsidiary relationship in the setting of a scope of information disclosure at the time of project registration, or to efficiently compile only information about the organizations in a parent-subsidiary relationship at the time of compiling.

The General flag 804 is an identifier showing a group general organization. The General flag 804 is set to “1” if an organization is an organization responsible for general control over group companies, and is set to “0” if this organization is not an organization responsible for general control over the group companies. If an information disclosure policy of a project is set in such a manner as to “share project information and transaction data 500” and not to share settlement information, for example, the settlement information is shared only between one's own organization and an organization with the General flag 804 set to “1.” The organization information 431 is not limited to the Organization ID 701, the Organization name 802, the Parent company 803, and the General flag 804 but an address, a telephone number, etc. may also be used. While the example in FIG. 7 shows management on a company basis, management may be exercised on an organization basis in a company such as a sales department or a public affairs department.

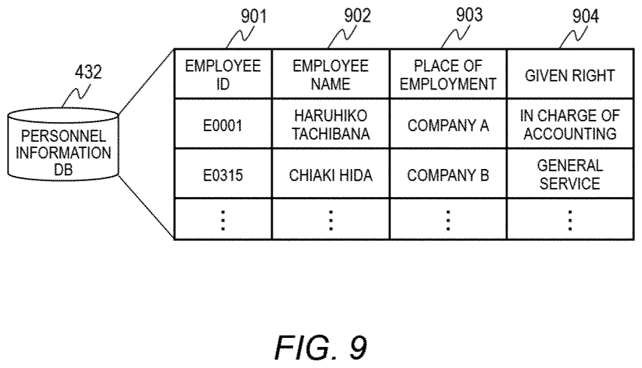

FIG. 9 is an explanatory view showing an example of the personnel information 432. The personnel information 432 includes managed information about a hired employee. The personnel information 432 includes an Employee ID 901, an Employee name 902, a Place of employment 903, and a Given right 904. The Employee ID 901 is identification information for identifying an employee uniquely. The Employee name 902 is the name of an employee identified by the Employee ID 901. The Placement of employment 903 is an organization to which an employee identified by the Employee ID 901 belongs (a company or a department in a company, for example). The Given right 904 is the scope of a right permitting an employee identified by Employee ID 901 to perform operations.

The Given right 904 includes information set for determining whether the Given right 904 is available if there arises a need for Given right 904 for the registration of project information, an application for issuance of a project coin, etc. If only an employee having the Given right 904 “In charge of accounting” is permitted to apply for issuance of a project coin, for example, “Haruhiko TACHIBANA” is permitted to apply for issuance of a project coin. However, “Chiaki HITASHI” is not permitted to apply for issuance of a project coin. The personnel information 432 includes not only the Employee ID 901, the Employee name 902, the Place of employment 903, and the Given right 904, but also an E-mail address, an extended number, etc.

### <Exemplary Screens>

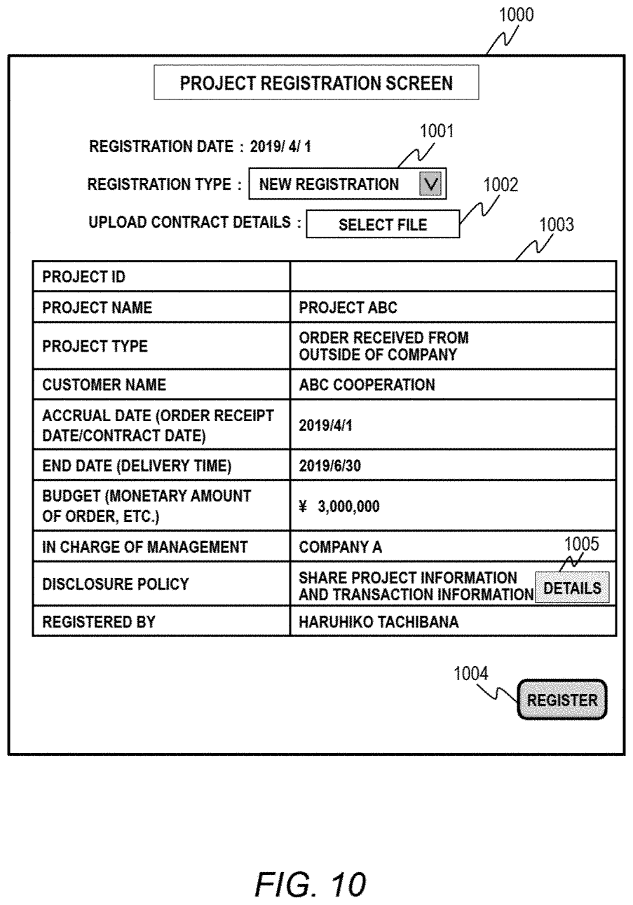

Exemplary screens displayed on the output device 304 of the accounting management apparatus 201X or an external terminal not shown communicably connected to the accounting management apparatus 201X will be described using FIGS. 10 to 15. The screens shown in FIGS. 10 to 15 are displayed when a user logs into the accounting management apparatus 201X.

Participating channel 704 used by the accounting management apparatus 201X is designated in advance before the screens shown in FIGS. 10 to 15 are displayed. More specifically, information acquired from the screen shown in each of FIGS. 10 to 15 is registered as the transaction data 500 with the distributed ledger 210X of the accounting management apparatus 201X, and is also transmitted to the accounting management apparatus 201Y belonging to Participating channel 704 and registered with the distributed ledger 210Y.

### [Project Registration Screen]

FIG. 10 is an explanatory view showing an exemplary project registration screen. A project registration screen 1000 is a screen for the registration and update of a project. The project registration screen 1000 includes a registration type input region 1001, a contract specification upload field 1002, a project content input region 1003, and a registration button 1004.

The registration type input region 1001 is a region for selection and input of a registration type. The registration type includes “New registration,” “Change,” and “Finish.” A user can register a new project by selecting “New registration” in the registration type input region 1001. The user can change the contents of a registered project by selecting “Change” in the registration type input region 1001. The user can register completion of a registered project by selecting “Finish” in the registration type input region 1001.

The contract details upload field 1002 is a field for the selection of a file of contract details intended to be uploaded. If a file such as that of a contract details at the time of receipt of an order for a project to be registered is selected in the contract details upload field 1002, this file is uploaded from the storage device 302.

The project contents input region 1003 is a region for the input of project information corresponding to the contents of a project. The project information is stored in the distributed ledger 210X. The project information input to the project contents input region 1003 includes a Project ID, a Project name, a Project type, a Customer name, an Accrual date, an End date, a Budget, an ‘In charge of management’, a Disclosure policy, and a ‘Registered by’. If “New registration” is set in the registration type input region 1001, the Project name, the Project type, the Customer name, the Accrual date, the End date, the Budget, the ‘In charge of management’, and the Disclosure policy become blank and a person to register logging into the accounting management apparatus 201X operates the input device 303 to make inputs to these fields.

The Project type is a type of a project identified by the Project ID. In the case of a project started in response to an order received from a customer, “Order received from outside of company” is input to the Project type. In the case of a project started in response to activities in a company, “Activities in company” is input to the Project type. Alternatively, one of the predetermined project types may be input to the Project type.

The End date is a date on which a project identified by the Project ID comes to an end. If a project is to be registered newly and if an end date of this project has not been settled, an expected date of delivery to a customer can be input as the End date.

The Budget is the cost planned for a project identified by the Project ID. An amount of an order received from a customer or an amount allocated for activities in a company is input to the Budget.

The ‘In charge of management’ is a management subject of a project identified by the Project ID. The name of a company or an organization to be mainly responsible for this project is input to the ‘In charge of management’. If a company A receives an order for system development, for example, from ABC cooperation and the company A is to be mainly responsible for the case for which the order has been received, “ABC cooperation” is input as the Customer name and “Company A” is input as the ‘In charge of management’.

The Disclosure policy is a policy about the scope of disclosure of the project information with the distributed ledger 210X. When a detail button 1005 is pressed, a scope of disclosure is displayed in a pop-up screen (not shown) in a manner permitting selection of the scope of disclosure. For example, a person to register can prevent the sharing of settlement information by selecting “Share project information and transaction information” in the pop-up screen. The person to register can permit the sharing of all pieces of information including the settlement information by selecting “share all pieces of information”. Regarding the Project type or the ‘In charge of management’ other than the Disclosure policy, information for which alternatives are prepared in advance can be input by being selected in a style such as a pull-down style.

The person to register is an employee registered with the personnel information 432. When the person to register presses the registration button 1004, the acquisition unit 411 accepts this input and transfers the input to the registration unit 412. Then, the registration unit 412 registers the project information input to the project registration screen 1000 as the transaction data 500 with a designated block in the distributed ledger 210X.

If the Registration type is “New registration,” a project ID is newly issued, and the issued project ID is registered together with it. If the Disclosure policy is “Share project information and transaction information,” the Registration date (time stamp), the Registration type, the Contract document, the Project ID, the Project name, the Project type, the Customer name, the Accrual date, the End date, the ‘In charge of management’, the Disclosure policy, and the ‘Registered by’ are registered as project information with the distributed ledger 210X in a manner permitting the sharing of these items among all group companies. Further, the Time stamp, the Project ID, the Budget, and the ‘Registered by’ are registered as settlement information with the distributed ledger 210X in a manner permitting the sharing of these items only between a group general organization and an organization to be in charge of management.

The Project information to be registered not only includes the Registration date (time stamp), the Registration type, the Contract document, the Project ID, the Project name, the Project type, the Customer name, the Occurrence date, the End date, the ‘In charge of management’, the Disclosure policy, and the ‘Registered by’, but it may also include information such as information specific to a pertinent business field required to be shared among predetermined group companies.

### [Transaction Screen]

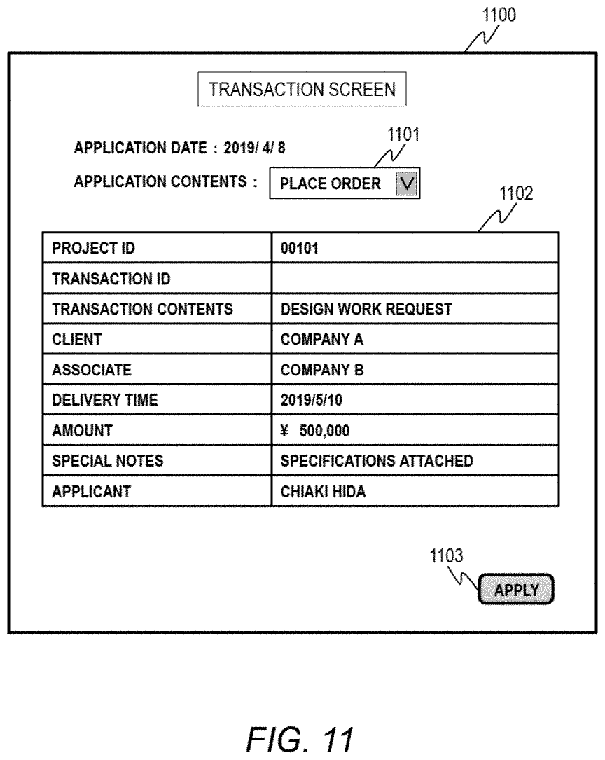

FIG. 11 is an explanatory view showing an exemplary transaction screen. A transaction screen 1100 is a screen displayed for making transactions such as giving and receipt of orders. The transaction screen 1100 includes an application contents input region 1101, a transaction contents input region 1102, and an application button 1103.

The application contents input region 1101 is a region for the selection and input of an application contents about a transaction. An applicant can give an order by selecting “Give order” in the application contents input region 1101. In the application contents input region 1101, the applicant can request an estimate before giving a formal order by selecting “Request estimate,” can reply to the request for the estimate by selecting “Reply to estimate,” can proceed to shipment of a product or delivery through an electronic medium from an order receiving side by selecting “Deliver,” and can notify completion of the receiving inspection of a delivered item by selecting “Receiving inspection finished.”

The transaction contents input region 1102 is a region for the input of a transaction contents. A transaction contents to be input to the transaction contents input region 1102 includes a Project ID, a Transaction ID 501, a Transaction contents, a Client, an Associate, a Delivery time, an Amount, a Special note, and an Applicant. The Project ID is ready to be input in the presence of a project relating to this transaction. If design work relating to a project with Project ID “00101” is to be subcontracted from a company A to a company B, for example, “00101” is input to Project ID, a “Design work request” is input to the Transaction contents, “Company A” is input to the Client, and “Company B” is input to the Associate.

Regarding a transaction having already occurred, Transaction ID 501 about this transaction is ready to be input in response to an application for a transaction of a different status. A special note, if any, can be input in relation to the transaction. If there is a specification attached separately, “Specification attached” is input. The Applicant is an employee registered with the personnel information 432.

If an application contents selected in the application contents input region 1101 is an “Estimate request,” an applicant can input a budget as an amount, or may not input an amount. If an application contents selected in the application contents input region 1101 is “Delivery,” the applicant inputs a shipment date or a delivery date, not a delivery time. In this case, the applicant is not required to input an amount.

When the applicant operates the application button 1103, the acquisition unit 411 accepts this input and transfers the input to the transaction management unit 413. Then, the transaction management unit 413 registers the information input to the transaction screen 1100 with a designated block in the distributed ledger 210X. In the case of a transaction without a Transaction ID 501, a Transaction ID 501 is newly issued, and the issued Transaction ID 501 is registered together with it.

If the Disclosure policy of a project (see FIG. 10) identified by the Project ID in the transaction contents input region 1102 is “Share project information and transaction information,” the transaction information including the Application date (time stamp), the Application contents (status), the Project ID, the Transaction ID 501, the Transaction contents, the Client, the Associate, the Delivery time, the Special note, and the Applicant is registered as the transaction data 500 with the distributed ledger 210X in a manner permitting sharing of the transaction information among all group companies. If an amount is input to the transaction contents input region 1102, settlement information including the Time stamp, the Application contents, the Transaction ID 501, the Amount, and the Applicant is registered as the transaction data 500 with the distributed ledger 210X in a manner permitting sharing of the settlement information only between a group umbrella organization and an organization to be in charge of management.

The transaction data 500 to be registered not only includes a Project ID, a Transaction ID 501, a Transaction Contents, a Client, an Associate, a Delivery time, a Special Note, and an Applicant, but it may also include information required to be shared among predetermined group companies.

### [Project Coin Issuance/Cashing Application Screen]

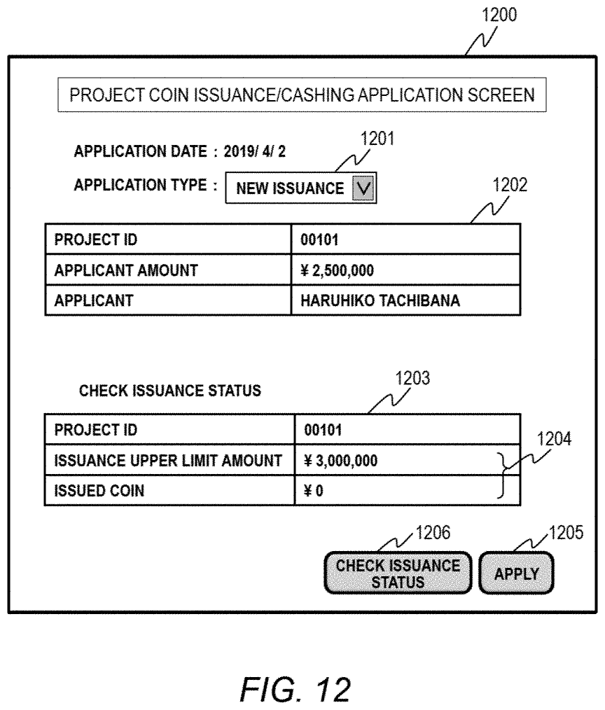

FIG. 12 is an explanatory view showing an exemplary project coin issuance/cashing application screen. A project coin issuance/cashing application screen 1200 is a screen for an application for the issuance of a project coin and the exchange of a project coin to cash. The project coin issuance/cashing application screen 1200 includes an application type input region 1201, an application contents input region 1202, an issuance check input region 1203, an application button 1205, and an issuance check button 1206.

The application type input region 1201 is a region for the selection and input of an application type. An applicant can newly apply for the issuance of a project coin for a project for which a project coin has yet to be issued by selecting “New issuance” in the application type input region 1201. The applicant can proceed to additional issuance of a project coin for a project for which a project coin has already been issued by selecting “Additional issuance” in the application type input region 1201. Further, the applicant can proceed to exchange of a project coin already issued to cash by selecting “Cashing” in the application type input region 1201.

The application contents input region 1202 is a region for the input of an application contents required for issuance of a project coin and exchange to cash. Information to be input to the application contents input region 1202 includes a Project ID, an Application amount, and an Applicant. The Project ID to be input is a project ID of a project for which the issuance of a project coin or exchange of a project coin to cash is desired. The Application amount to be input is an amount of a project coin desired to be issued for this project or an amount of a project desired to be exchanged to cash for this project. Referring to the example shown in FIG. 12, the issuance of a project coin corresponding to an amount “2,500,000 yen” is newly applied for in a project with Project ID “00101,” and this application is made by “Haruhiko TACHIBANA.”

When the applicant presses the application button 1205, the acquisition unit 411 accepts this input and transfers the input to the currency exchange unit 414. Then, the currency exchange unit 414 registers the contents of the application with a designated block in the distributed ledger 210X. In response to the application button 1205 being pressed, the currency issuance apparatus 202 acquires the application contents in the application contents input region 1202 from the accounting management apparatus 201X, and issues a project coin corresponding to the application amount. Then, the currency issuance apparatus 202 registers the contents of the issuance as the transaction data 500 with a designated block in the distributed ledger 210X.

The project coin issuance/cashing application screen 1200 also permits the checking of an issuance status of a project coin. When a project ID is input to the issuance check input region 1203 and the issuance check button 1206 is pressed, the acquisition unit 411 accepts this input and transfers the input to the currency exchange unit 414. Then, the currency exchange unit 414 calculates an issuance upper limit amount for a project and a total issued amount of a project coin on the basis of the transaction data 500 about the issuance contents registered with the distributed ledger 210X, and outputs the calculated amounts to an issuance status output region 1204.

### [Settlement Screen]

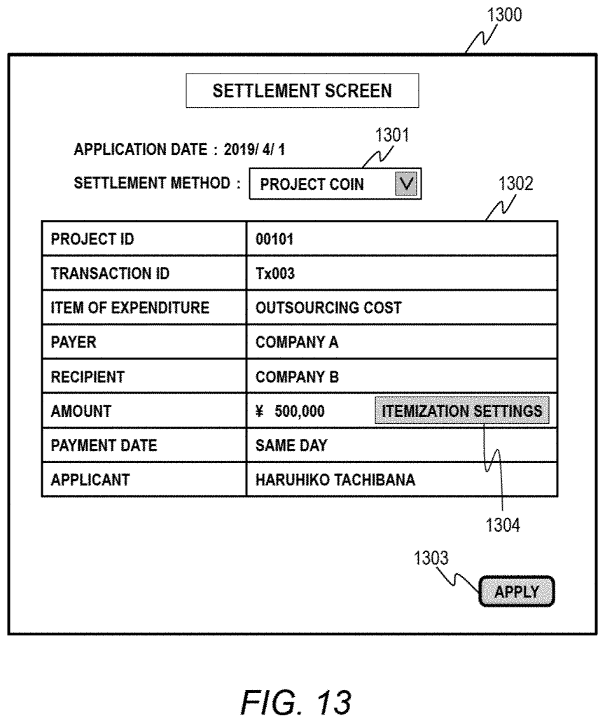

FIG. 13 is an explanatory view showing an exemplary settlement screen. A settlement screen 1300 is a screen for the input of information about a settlement. The settlement screen 1300 includes a settlement method input region 1301, a settlement content input region 1302, and an application button 1303.

The settlement method input region 1301 is a region for the selection and input of a settlement method to be used. An applicant can make a settlement using only a project coin by selecting “Project coin” in the settlement method input region 1301. The applicant can use a project coin and cash in combination by selecting “Project coin+cash,” and can make a settlement only in cash by selecting “Cash” in the settlement method input region 1301.

The settlement contents input region 1302 is a region for the input of information required for a settlement (settlement information). Information to be input to the settlement contents input region 1302 includes a Project ID, a Transaction ID 501, an Expense item, a Payer, a Recipient, an Amount, a Payment date, and an Applicant. Inputs given in the example of FIG. 13 show that, regarding a transaction with Transaction ID 501 “Tx003” for a project with Project ID “00101,” “500,000 yen” is to be paid on the “Same day” as the “Outsourcing cost” from “Company A” to “Company B”. Payment data may be designated by inputting a date, not by inputting “Same day.”

If “Project coin+cash” is selected as a settlement method in the settlement method input region 1301, an applicant can set a breakdown by pressing a breakdown setting button 1304. In the example shown in FIG. 13, a settlement is to be made using only a project coin. Alternatively, it can be set in such a manner as to use a project coin and cash in combination, and to pay an amount corresponding to “300, 000 yen” in project coins and pay an amount corresponding to “200,000 yen” in cash. It can also be set in such a manner as to use this project coin for a project and a project coin for a different finished project.

When the applicant presses the application button 1303, the acquisition unit 411 accepts this input and transfers the input to the settlement unit 415. Then, the settlement unit 415 performs a settlement process and registers settlement information with a designated block in the distributed ledger 210X. For the implementation of the settlement process by the settlement unit 415, a settlement ID is given and also registered as the settlement information.

If the Disclosure policy of a project (see FIG. 10) identified by the Project ID in the settlement contents input region 1302 is “Share project information and transaction information,” settlement information including the Settlement date (time stamp), the Settlement ID, the Settlement method, the Project ID, the Transaction ID 501, the Expense item, the Payer, the Recipient, the Amount, the Payment date, and the Applicant is registered as the transaction data 500 with the distributed ledger 210X in a manner permitting the sharing of the settlement information only between a group general organization and an organization to be in charge of management. When the settlement process is finished, the transaction data 500 is registered with the distributed ledger 210X in such a manner that a status of a transaction input to the Transaction ID 501 turns to “Settlement finished.” The registered transaction data 500 is shared among all group companies according to the Disclosure policy.

### [Aggregate Screen]

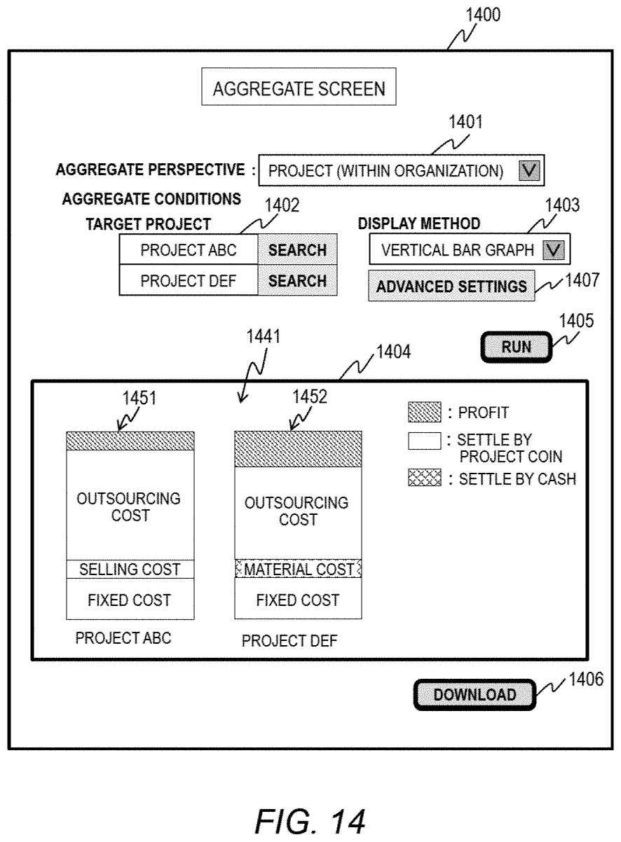

FIG. 14 is an explanatory view showing an example of a first aggregate screen. A first aggregate screen 1400 is displayed on the output device 304 of the accounting management apparatus 201X other than a group general organization and an external terminal not shown communicably connected to this accounting management apparatus 201X. The first aggregate screen includes a first aggregate perspective input region 1401, a target project input region 1402, a display method input region 1403, a first aggregate result display region 1404, an aggregate execution button 1405, and a download button 1406.

The first aggregate perspective input region 1401 is a region for the selection and input of a viewpoint from which an operator compiles information. The operator can compile information for the purpose of comparing a plurality of projects within an organization by selecting “Project (within organization)” in the first aggregate perspective input region 1401. The operator can compile not only earnings details within an organization but also earnings details for all group companies by selecting “Project (details of entire group)”. The operator can compile transitions of earnings on the basis of a set period such as a seasonal basis or a yearly basis within an organization by selecting “Chronological order (within organization).” An aggregate perspective selectable in the first aggregate perspective input region 1401 is not limited to those shown in this embodiment.

In FIG. 14, “Project (within organization)” is selected in the first aggregate perspective input region 1401. Here, it is assumed that a company A is to compare earnings from two projects, an ABC project and a DEF project.

The target project input region 1402 is a region for input of a project name as an aggregate target. A project name may directly be input to the target project input region 1402. Alternatively, a project name may be searched from a list of projects or may be found by inputting a part of the project name in the target project input region 1402. The number of projects which are aggregate targets is not limited to two but may be three or more. Alternatively, a single project may be an aggregate target.

The display method input region 1403 is a region for the selection and input of a method of displaying an aggregate result. While “Vertical bar graph” is used in the example of FIG. 14, widely known other aggregate display methods such as a crossbar graph, a line graph and a table are applicable. Details of aggregate conditions can be set by pressing an advanced settings button. For example, setting can be made to determine whether either one or both of a budget and a result of a project which is an aggregate target are to be displayed, whether explanatory notes are to be given in a display method selected in the display method input region 1403, etc. In the case shown in FIG. 14, only a result is displayed.

The first aggregate result display region 1404 is a region for display of a first aggregate result 1441. The first aggregate result 1441 includes settlement information (earnings, outsourcing cost, selling cost, fixed cost) 1451 relating to “ABC project”, and settlement information (earnings, outsourcing cost, material cost, fixed cost) 1452 relating to “DEF project. When the operator presses the aggregate execution button 1405, the acquisition unit 411 accepts this input and transfers the input to the aggregate unit 416. Then, the aggregate unit 416 performs a compilation process, and outputs the first aggregate result 1441 to the first aggregate result display region 1404. In the example shown in FIG. 14, regarding earnings from transactions relating to the ABC project and the DEF project that can be determined from the transaction data 500, these earnings are calculated by compiling information about each of the projects registered as settlement information.

When the operator operates the download button 1406, the acquisition unit 411 accepts this input and transfers the input to the aggregate unit 416. Then, the aggregate unit 416 performs a process of downloading an aggregate result. Regarding the format of a file to be downloaded, only aggregate data may be downloaded as a CSV file or as a table format, or a graph chart or an aggregate screen may be downloaded in a format such as PDF, PNG, or JPEG, for example. The format of a file to be downloaded can be selected freely by the operator.

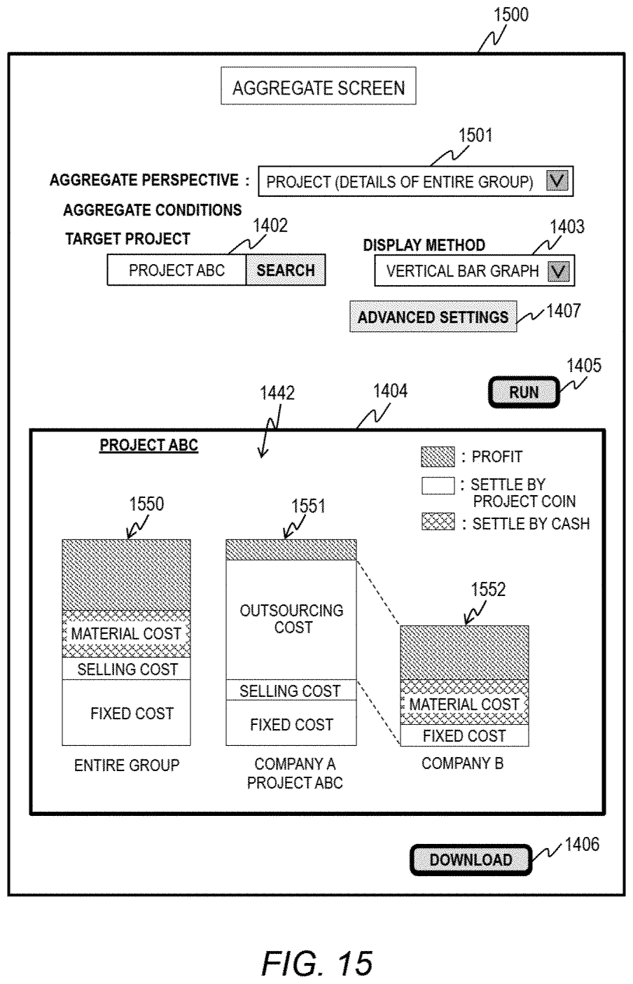

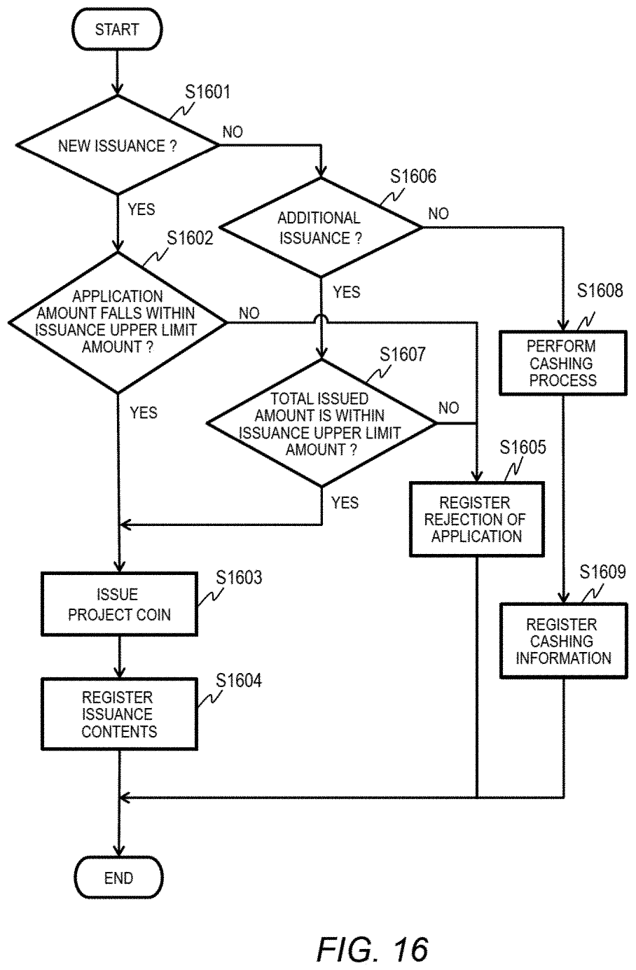

FIG. 15 is an explanatory view showing an example of a second aggregate screen. A second aggregate screen 1500 is displayed on the output device 304 of the accounting management apparatus 201X as a group general organization and an external terminal not shown communicably connected to this accounting management apparatus 201X. The second aggregate screen 1500 includes a second aggregate perspective input region 1501, a target project input region 1402, a display method input region 1403, a second aggregate result display region 1504, an aggregate execution button 1405, and a download button 1406. A structure with the same signs as that in FIG. 14 is the same as the corresponding structure in FIG. 14 and will not be described. The second aggregate screen 1500 will be described mainly in terms of differences from FIG. 14.

The second aggregate perspective input region 1501 is a region for the selection and input of a viewpoint from which an operator compiles information. In FIG. 15, “Project (entire group in detail)” is selected in the second aggregate perspective input region 1501. Here, it is assumed that a group umbrella organization is to compile earnings from an ABC project for all group companies. The second aggregate result display region 1504 is a region for the display of a second aggregate result 1442.

When the operator operates the aggregate execution button 1405, the acquisition unit 411 accepts this input and transfers the input to the aggregate unit 416. Then, the aggregate unit 416 performs an compilation process, and the second aggregate result 1442 is displayed in the second aggregate result display region 1504. The second aggregate result 1442 includes settlement information (earnings, outsourcing cost, selling cost, fixed cost) 1551 about a company A relating to “ABC project,” settlement information (earnings, material cost, fixed cost) 1552 about a company B as a destination of outsourcing, and settlement information 1550 for an entire group (in this example, company A and company B) relating to “ABC project” resulting from compilation of the settlement information 1551 and the settlement information 1552.

In the example shown in FIG. 15, regarding earnings from transactions relating to the ABC project that can be determined from the transaction data 500, these earnings are calculated by compiling the transaction data 500 registered as the settlement information 1551 and the settlement information 1552 of all group companies. The settlement information 1552 determined at the time of outsourcing from the company A to the company B corresponds to cost displayed as “Outsourcing cost” as a result of compiling only for company A. On the other hand, the profits of all the group companies can be grasped by giving further consideration to an earnings structure of the company B.

The example shown in FIG. 15 results from the operations performed by the group umbrella organization sharing the settlement information. This permits the compilation of an earnings structure of the entire group. On the other hand, the distributed ledger 210X owned by the company A or the company B contains only settlement information about the company A or the company B itself and does not contain the shared settlement information. This prohibits the accounting management apparatus 201X other than the group umbrella organization from executing the aggregate such as that shown in FIG. 15.

As described above, access to information to be shared in the distributed ledger 210X is controlled using a channel. This permits the compilation of the earnings of an entire group only by an organization required to grasp an earnings structure of the entire group, while permitting each company belonging to the group to compile only earnings relating to a transaction in which the company is directly involved. As an organization required to grasp the earnings structure of the entire group is permitted to share settlement information using the distributed ledger 210X, each company belonging to the group can be relieved of the burden of collecting the data necessary for compiling and providing the collected data to the group umbrella organization.

### <Project Coin Issuance Process>

FIG. 16 is a flowchart showing an exemplary procedure of a project coin issuance process performed by the currency issuance apparatus 202. The currency issuance apparatus 202 refers to the transaction data 500 about an application contents registered with the distributed ledger 210X illustrated in FIG. 12 to determine whether a type of application for the issuance of a project coin is a “New issuance” (step S1601). If the application type is “New issuance” (step S1601: Yes), the currency issuance apparatus 202 determines whether an applied amount of the project coin falls within an issuance upper limit amount permitted for a project (step S1602).

If the application amount of the project coin falls within the issuance upper limit amount permitted for the project (step S1602: Yes), the currency issuance apparatus 202 issues a project coin corresponding to the application amount (step S1603). Then, the currency issuance apparatus 202 registers a contents of the issuance as the transaction data 500 with the distributed ledger 210X (step S1604), and finishes the issuance process.

In step S1602, if the application amount of the project coin is determined not to fall within the issuance upper limit amount permitted for the project (step S1602: No), the currency issuance apparatus 202 registers rejection of the application for the project coin as the transaction data 500 with the distributed ledger 210X (step S1605), and finishes the issuance process.

In step S1601, if the type of application for the issuance of the project coin is determined not to be a “New issuance” (step S1601: No), the currency issuance apparatus 202 determines whether the type of application for issuance of the project coin is “Additional issuance” (step S1606). If the application type is “Additional issuance” (step S1606: Yes), the currency issuance apparatus 202 determines whether a total issued amount of the project coin is within the issuance upper limit amount permitted for the project (step S1607).

If the total issued amount of the project coin is within the issuance upper limit amount permitted for the project (step S1607: Yes), the procedure goes to step S1603. If the total issued amount of the project coin is not within the issuance upper limit amount permitted for the project (step S1607: No), the procedure goes to step S1605.

In step S1606, if the type of application for the issuance of the project coin is determined not to be “Additional issuance” (step S1606: No), the application type is “Cashing.” Then, the currency issuance apparatus 202 performs a cashing process for exchanging the project coin applied for to cash (step S1608), registers information about the cashing as the transaction data 500 with the distributed ledger 210X (step S1609), and finishes the issuance process. While the process in FIG. 16 is performed by the currency issuance apparatus 202, it may alternatively be performed by the currency exchange unit 414 in each accounting management apparatus 201X.

### <Settlement Process>

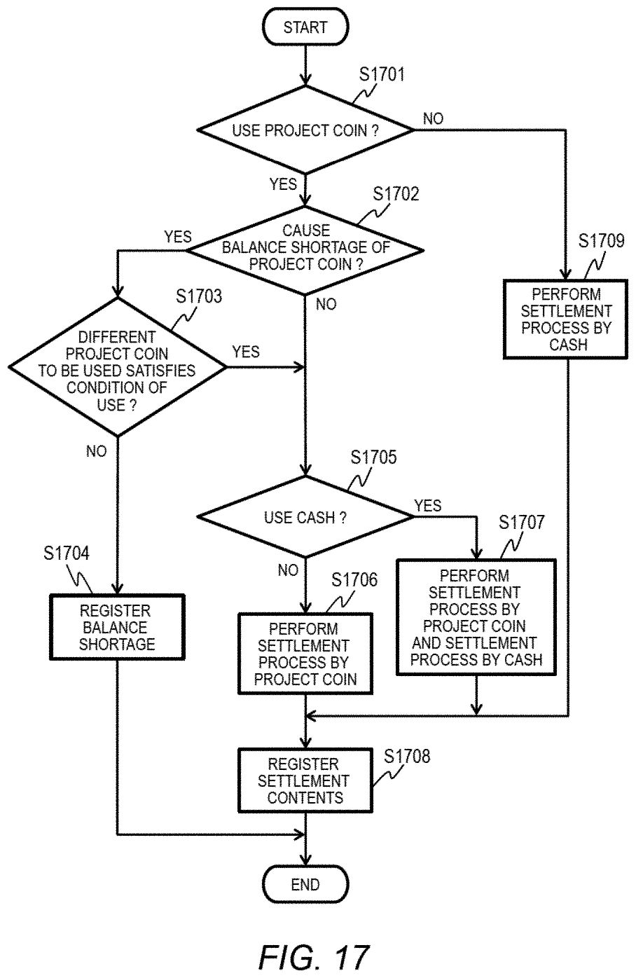

FIG. 17 is a flowchart showing an exemplary procedure of a settlement process performed by the settlement unit 415 of the accounting management apparatus 201X. The settlement unit 415 determines whether a settlement method applied for in the settlement method input region 1301 illustrated in FIG. 13 is a method using a project coin (step S1701). Methods using the project coin include a method of using only the project coin responsive to selection of “Project coin” in the settlement method input region 1301, and a method of using the project coin and cash responsive to selection of “Project coin+cash” in the settlement method input region 1301.

If the project coin is to be used (step S1701: Yes), the settlement unit 415 determines whether using the project coin causes a balance shortage of the project coin owned by an organization to which an applicant belongs in the Place of employment 903 (step S1702). Namely, the settlement unit 415 determines whether an amount input to the settlement contents input region 1302 is greater than the balance of the project coin owned by the organization to which the applicant belongs indicated by the Place of employment 903. The balance of the project coin owned by the organization to which the applicant belongs indicated by the Place of employment 903 can be calculated from the transaction data 500 about settlement information registered with the distributed ledger 210X.

If a balance shortage of the project coin is to be caused (step S1702: Yes), the settlement unit 415 determines whether a different project coin to be used satisfies a condition of use (step S1703). “Different project coin to be used” means that a project coin issued for a DEF project is set to be used in making a settlement of a transaction about an ABC project, for example. A condition of use is a condition defining permission for the diversion of a different project coin. The definition is such that, if a different project which is a diversion target is finished and registered, a different project coin becomes available for diversion, for example.

If there is no different project coin to be used, and if there is a different project coin to be used and the different project coin satisfies the condition of use (step S1703: Yes), the procedure goes to step S1705. If there is no different project coin to be used, or if there is a different project coin to be used but the different project coin does not satisfy the condition of use (step S1703: No), the settlement unit 415 registers the balance shortage as the transaction data 500 with the distributed ledger 210X (step S1704), and then finishes the settlement process.

In step S1702, if a balance shortage of the project coin is determined not to be caused (step S1702: No), the procedure goes to step S1705. In step S1705, the settlement unit 415 determines whether the method of using the project coin determined in step S1701 includes use of cash (step S1705). Namely, the settlement unit 415 determines whether the method of using the project coin is a method of using the project coin and cash.

If cash is not to be used (step S1705: No), the settlement unit 415 performs a settlement process using the project coin (step S1706), and then goes to step S1708. If cash is to be used (step S1705: Yes), the settlement unit 415 performs a process of making a settlement with the project coin and making a settlement in cash (step S1707), and then goes to step S1708. In step S1708, the settlement unit 415 registers information about the settlement in step S1706 or S1707 as the transaction data 500 with the distributed ledger 210X (S1708), and then finishes the settlement process.

In step S1701, if the project coin is determined not to be used (step S1701: No), namely, only cash is determined to be used, the settlement unit 415 performs a cash settlement process (step S1709), and then goes to step S1708.

<Earnings Compilation Process within the Entire Group>

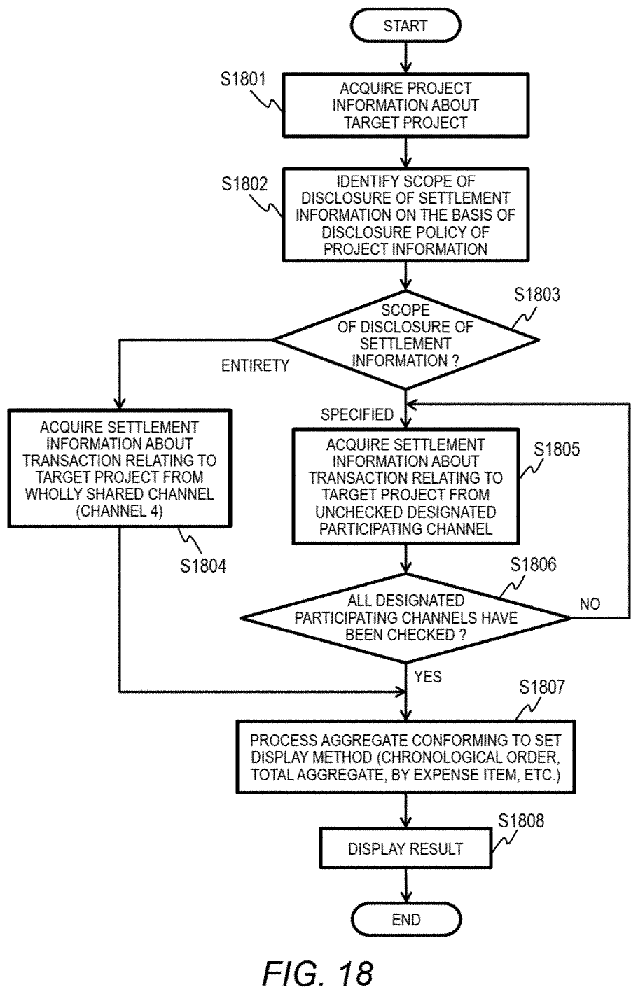

FIG. 18 is a flowchart showing an exemplary procedure of an earnings compilation process of an entire group performed by the accounting management apparatus 201A of a group umbrella organization. The accounting management apparatus 201A of the group umbrella organization designates a project ID of a target project, and acquires project information about the target project from the distributed ledger 210X (step S1801). The target project is identified in the target project input region 1402 shown in FIG. 15. The project information is the transaction data 500 including the project ID. The accounting management apparatus 201X identifies a scope of disclosure of settlement information on the basis of a disclosure policy in the acquired project information (see FIG. 5B) (step S1802).

If the scope of disclosure is such that the settlement information is to be shared entirely (corresponding to the channel 4) (step S1803: Entirely), the accounting management apparatus 201A of the group umbrella organization acquires settlement information about the target project from the distributed ledger 210X of a channel defining entire sharing (channel 4 shown in FIG. 6, for example) (step S1804), and then goes to step S1807.

By contrast, if there is a designated scope of disclosure of settlement information (step S1803: Designated), the accounting management apparatus 201A of the group umbrella organization acquires settlement information about the target project from a channel determined to be unchecked in step S1806 belonging to Participating channel 704 designated as the scope of disclosure (step S1805). Then, the accounting management apparatus 201X of the group umbrella organization determines whether the designated Participating channel 704 has been checked completely (step S1806). If the designated Participating channel 704 has not been checked completely (step S1806: No), the procedure returns to step S1805.

If the designated Participating channel 704 has been checked completely (step S1806: Yes), the procedure goes to step S1807. In step S1807, the accounting management apparatus 201A of the group general organization performs a compilation process in such a manner as to conform to a display method set in the display method input region 1403 (chronological order, entire aggregate, for each expense item, for example), displays the second aggregate result 1442 in the second aggregate result display region 1504 (step S1808), and then finishes the compilation process.

While the accounting management apparatus 201X according to the foregoing embodiment has been described as an apparatus that registers information about the issuance of a project coin, the prohibition of issuance of a project coin, the completion of a settlement in the settlement process, and the prohibition of a settlement with the distributed ledger 210X, it may alternatively be configured to notify an applicant of such pieces of information in response to registration thereof with the distributed ledger 210X as a trigger. The notification to the applicant can be made automatically using a smart contract, for example.

Of project information or the transaction data 500, information to be stored into the distributed ledger 210X by the accounting management apparatus 201X may only be information required to be shared, and accessory information to be used only in one's own company or one's own organization may be stored in a conventional database such as an RDB.

As described above, in the accounting management system 200, the accounting management apparatus 201X makes settlements within a company and between group companies using a project coin as a company-specific currency for which a transaction contents is to be stored, and accumulates transaction contents and settlement information about each project in association with each other in the distributed ledger 210X. Further, by using the channel setting information 421, the accounting management apparatus 201X executes the control of access to information to be shared in the distributed ledger 210X on a project basis.

As a result, it becomes possible for the organization A responsible for general control over all the group companies A to G to grasp an earnings structure on a project basis across the group companies B to G while the group companies A to G do not disclose their earnings to each other. Moreover, as information to be stored includes transaction contents and settlement information, wrongdoing or falsification in accounting or in making a transaction can be prevented.

(1) The accounting management apparatus 201X, which manages accounting of a first organization (company A) belonging to a set of organizations (companies A to G) forming a group, includes the processor 301 that executes a program and the storage device 302 that stores the program. The processor 301 is accessible to the accounting information (distributed ledger 210A) including information about a project of the first organization (company A) and settlement information about the project. The processor 301 performs: an acquisition process of acquiring first settlement information about the project and second settlement information from the accounting information, the second settlement information being about a part of operation of the project by a second organization belonging to the group and having performed part of the operation, the acquisition process being performed using the acquisition unit 411; a compilation process of compiling the first settlement information and the second settlement information acquired by the acquisition process, the compilation process being performed using the compilation unit 416; and an output process of outputting a result of the compiling by the compilation process.

As a result, it becomes possible for the organization A responsible for general control over all the group companies A to G to grasp the configuration of settlement information on a project basis across the group companies A to G.

(2) In the foregoing (1), in the acquisition process, the processor 301 may make the acquisition unit 411 acquire the second settlement information from the distributed ledger 210A on the basis of a scope of disclosure of the settlement information defined in the information about the project.

This permits compilation of the second settlement information according to a disclosure policy.

(3) In the foregoing (1), in the compilation process, the processor 301 may make the compilation unit 416 compile first amount data about a particular account title in the first settlement information and second amount data about the particular account title in the second settlement information. This permits compilation of the first settlement information and the second settlement information on the basis of an account title.

(4) In the foregoing (3), the particular account title may be an account title indicating a profit. This permits the organization A responsible for general control over all the group companies B to G to grasp an earnings structure on a project basis across the group companies B to G.

(5) In the foregoing (1), the accounting information may be a distributed ledger configured using a block chain. This makes it possible to easily acquire the transaction data 500 generated by the accounting management apparatus 201A or the transaction data 500 from each of the accounting management apparatuses B to G.

(6) In the foregoing (5), the storage device 302 may store the channel setting information 421 containing settings of one or more channels defining the accounting management apparatus 201X of a different organization which will to become a partner in the communication of information, and the processor 301 may perform a transmission process through the communication IF 305 of transmitting transaction data including the first settlement information to the accounting management apparatus (201B) of the different organization (company B, for example) identified from a designated channel (channel 1, for example).

This permits the accounting management apparatus 201A to register the transaction data 500 with only their own distributed ledger 210A and the distributed ledger 210B of the accounting management apparatus 201B of the company B participating in the designated channel 1. In this way, this transaction data 500 is undisclosed to the other accounting management apparatuses 201C to 201G.

In the foregoing (5), in response to receipt of the transaction data 500 including the second settlement information from the accounting management apparatus (201B) of a different organization (company B, for example) in the group, the processor 301 may make the registration unit 412 perform a registration process of registering the second settlement information with the distributed ledger 210A, and in the acquisition process, the processor 301 may acquire the first settlement information and the second settlement information registered by the registration process from the distributed ledger 210A.

As a result, it becomes possible for the organization A responsible for general control over all the group companies A to G to grasp an earnings structure on a project basis across the group companies A to G while the group companies A to G do not disclose their earnings to each other. Moreover, as information to be stored includes transaction contents and settlement information, wrongdoing or falsification in accounting or in making a transaction can be prevented.

It should be noted that this disclosure is not limited to the above-mentioned embodiments, and encompasses various modification examples and the equivalent configurations within the scope of the appended claims without departing from the gist of this disclosure. For example, the above-mentioned embodiments are described in detail for a better understanding of this disclosure, and this disclosure is not necessarily limited to what includes all the configurations that have been described. Further, a part of the configurations according to a given embodiment may be replaced by the configurations according to another embodiment. Further, the configurations according to another embodiment may be added to the configurations according to a given embodiment. Further, a part of the configurations according to each embodiment may be added to, deleted from, or replaced by another configuration.

Further, a part or entirety of the respective configurations, functions, processing modules, processing means, and the like that have been described may be implemented by hardware, for example, may be designed as an integrated circuit, or may be implemented by software by a processor interpreting and executing programs for implementing the respective functions.

The information on the programs, tables, files, and the like for implementing the respective functions can be stored in a storage device such as a memory, a hard disk drive, or a solid state drive (SSD) or a recording medium such as an IC card, an SD card, or a DVD.

Further, control lines and information lines that are assumed to be necessary for the sake of description are described, but not all the control lines and information lines that are necessary in terms of implementation are described. It may be considered that almost all the components are connected to one another in actuality.

What is claimed is:

1. An accounting management apparatus configured to manage accounting of a first organization belonging to a set of organizations forming a group, comprising:
a processor configured to execute a program; and
a storage device configured to store the program,
the accounting management apparatus being accessible to accounting information including information about a project of the first organization and settlement information about the project, and
the processor being configured to execute:
an acquisition process of acquiring first settlement information about the project and second settlement information from the accounting information, the second settlement information being about a part of operation of the project by a second organization belonging to the group and having performed part of the operation;
a compilation process of compiling the first settlement information and the second settlement information acquired by the acquisition process; and
an output process of outputting a result of the compilation by the compilation process.

2. The accounting management apparatus according to claim 1,
wherein, in the acquisition process, the processor acquires the second settlement information from the accounting information on the basis of a scope of disclosure of the settlement information defined in the information about the project.

3. The accounting management apparatus according to claim 1,
wherein, in the compilation process, the processor compiles first amount data about a particular account title in the first settlement information and second amount data about the particular account title in the second settlement information.

4. The accounting management apparatus according to claim 3,
wherein the particular account title is an account title indicating a profit.

5. The accounting management apparatus according to claim 1,
wherein the accounting information is a distributed ledger configured using a block chain.

6. The accounting management apparatus according to claim 5,
wherein the storage device stores setting information containing settings of one or more channels defining an accounting management apparatus of a different organization to become a partner in the communication of information, and
wherein the processor being configured to execute:
a transmission process of transmitting transaction data including the first settlement information to the accounting management apparatus of the different organization identified from a designated channel.

7. The accounting management apparatus according to claim 5,
wherein the processor being configured to execute:
in response to receipt of transaction data including the second settlement information from an accounting management apparatus of a different organization in the group, a registration process of registering the second settlement information with the accounting information; and
wherein, in the acquisition process, the processor acquires the first settlement information and the second settlement information registered by the registration process from the accounting information.

8. An accounting management method executed by an accounting management apparatus configured to manage accounting of a first organization belonging to a set of organizations forming a group,
the accounting management apparatus comprising:
a processor configured to execute a program; and
a storage device configured to store the program,
the accounting management apparatus being accessible to accounting information about the first organization including information about a project of the first organization and settlement information about the project,
the processor being configured to execute:
an acquisition process of acquiring first settlement information about the project of the first organization and second settlement information from the accounting information, the second settlement information being about a part of operation of the project by a second organization belonging to the group and having performed part of the operation;
a compilation process of compiling the first settlement information and the second settlement information acquired by the acquisition process; and
an output process of outputting a result of the compilation by the compile process.

9. The accounting management method according to claim 8,
wherein, in the acquisition process, the second settlement information is acquired from the accounting information on the basis of a scope of disclosure of the settlement information defined in the information about the project.

10. The accounting management method according to claim 8,
wherein, in the compilation process, the processor compiles first amount data about a particular account title in the first settlement information and second amount data about the particular account title in the second settlement information.

11. The accounting management method according to claim 10,
wherein the particular account title is an account title indicating a profit.

12. The accounting management method according to claim 8,
wherein the accounting information is a distributed ledger configured using a block chain.

13. The accounting management method according to claim 12,
wherein the storage device is configured to store setting information containing settings of one or more channels defining an accounting management apparatus of a different organization to become a partner in the communication of information, and
wherein the processor being configured to execute:
a transmission process of transmitting transaction data including the first settlement information to the accounting management apparatus of the different organization identified from a designated channel.

14. An accounting management system comprising a first accounting management apparatus that manages accounting of a first organization belonging to a set of organizations forming a group, and a second accounting management apparatus that manages accounting of a second organization in the organization set,
wherein the first accounting management apparatus being configured to execute:
a first settlement process of making a first settlement about a project of the first organization; and
a first registration process of registering first settlement information resulting from the first settlement process with first accounting information accessible from the first accounting management apparatus,
wherein the second accounting management apparatus being configured to execute:
a second settlement process of making a second settlement about a part of operation of the project;
a second registration process of registering second settlement information resulting from the second settlement process with second accounting information accessible from the second accounting management apparatus; and
a transmission process of transmitting the second settlement information to the first accounting management apparatus, and
the first accounting management apparatus performs:
a third registration process of registering the second settlement information with the first accounting information in response to receipt of the second settlement information transmitted by the transmission process:
an acquisition process of acquiring the first settlement information and the second settlement information from the first accounting information;
a compilation process of compiling the first settlement information and the second settlement information acquired by the acquisition process; and
an output process of outputting a result of the compiling by the compilation process.

15. The accounting management system according to claim 14,
wherein the second accounting management apparatus configured to store settings information containing settings of one or more channels defining an accounting management apparatus of a different organization to become a partner in the communication of information, and
wherein, if a channel defining the first accounting management apparatus as the communication counterpart is designated, in the transmission process, the second accounting management apparatus transmits transaction data including the second settlement information to the first accounting management apparatus.
